(19) United States
(12) Patent Application Publication
(10) Pub. No.: US 2023/0125727 A1
(43) Pub. Date: Apr. 27, 2023

(54) BIOLOGICAL ENGINE

(71) Applicant: Gautham Sivakumar, San Jose, CA (US)

(72) Inventor: Gautham Sivakumar, San Jose, CA (US)

(21) Appl. No.: 17/511,356

(22) Filed: Oct. 26, 2021

(51) Int. Cl. F03G 7/06

(52) U.S. Cl. CPC F03G 7/0618; F03G 7/06112; F03G 7/0641; F03G 7/062

(57) ABSTRACT

A biological engine is configured to transfer mechanical energy from a biological actuator. The biological engine has an enclosure containing a biological feedstock. A cylinder opening is arranged on a bottom side of the enclosure. A turbine hole is arranged on the bottom side of the enclosure. A turbine is arranged in the turbine hole with a turbine seal. A crankshaft assembly has a crankshaft joined to the turbine. A piston is joined to the crankshaft assembly. A cylinder surrounds the piston and connected to the cylinder opening. A biological actuator joins the piston and a cylinder head with an artificial tendon. An electrode pad touches the biological actuator and connected to a current source with a wire and an electrode connector. Electrical current from the current sources causes the biological actuator to expand and contract, moving the piston, turning the crankshaft and transferring the mechanical energy.

The embodiments herein relate generally to an engine that is powered by biological fuel. More specifically, the invention relates to a device that is capable of efficiently converting harmful greenhouse gases into useful biological fuel via photosynthesis, and then using that biological fuel to power vehicles, generators, and more.

Alternative renewable fuel sources are in greater need than ever before due to the impending crises of energy, environment, and the economy. Our planet's supply of fossil fuels is dwindling quickly, and gasoline prices are skyrocketing. In addition, climate change has been a rapidly growing area of concern lately. One of the biggest driving forces behind environmental pollution is the copious amount of emissions that go into the atmosphere on an everyday basis from cars. Gasoline-powered cars and power plants emit copious amounts of carbon dioxide, nitrogen gas, and other greenhouse gases that contribute heavily to global warming and climate change. According to the EPA, transportation and electricity account for over 55% of greenhouse gases produced. The IPCC (Intergovernmental Panel on Climate Change) reports that global emissions cuts are needed on an ‘unprecedented scale’ in order to read their target.

Many climate scientists and politicians have invoked the concept of negative emissions—sucking carbon dioxide back out of the atmosphere. Negative emission technologies are included by scientists in the majority of modeled pathways showing how the world can avoid the internationally agreed limit of staying well below 2° C. of global warming. Without deploying negative-emission technology at a global scale, many scientists predict that we will easily exceed this limit by the end of this century. For example, in the latest IPCC assessment report published in 2014, 101 of the 116 scenarios that achieved a “likely” chance of staying below 2° C. relied on negative-emission technology. 67% of these scenarios said that negative-emission technology would represent at least 20% of the world's primary energy by 2100. A recent study suggests that negative-emission technology could be used to sequester around 12 billion tons of CO2 per year globally. The biological engine and generator would allow us to supply the world's energy needs while simultaneously removing thousands of tons of carbon dioxide from the atmosphere every year. By halting and reversing the environmental damages caused by our world's industries, negative emission technology provides environmental and social benefits that other forms of renewable energy do not. Currently, one solution that already exists to gasoline-powered vehicles is electric cars. While the development of electricity-powered vehicles is a step in the right direction, there are still many flaws present with them. Although the usage of electricity is better for the environment than the burning of gasoline, the production of electricity requires a large amount of fossil fuels as well. As a result, the constant electricity use required to manufacture and charge electric cars still results in a large amount of fossil fuels being consumed every year. Although electric cars have a greatly minimized consumption of fossil fuels, their production and usage still continue to negatively impact our environment. In addition, owners have to charge their cars multiple times a week, which costs additional thousands of dollars and can pose an inconvenience to consumers. Despite all the progress we've made towards reducing fossil fuel usage, there are still many disadvantages with the current alternatives to gas-powered vehicles.

It would be desirable to have a ‘negative-emission’ engine that consumes carbon dioxide and other harmful greenhouse gases in order to power the motion of a vehicle or power an electrical generator. Furthermore, it would also be desirable to have an engine that requires zero fossil fuels to use and charge. Still further, it would be desirable to have a mechanism by which the engine is able to refuel itself without having to be plugged in, refueled, or recharged by the customer. Therefore, there currently exists a need in the industry for a biologically powered engine which uses photosynthesis to generate biological fuel and power mechanical motion.

### SUMMARY

A biological engine is configured to transfer mechanical energy from a biological actuator. The biological engine has an enclosure containing a biological feedstock. A cylinder opening is arranged on a bottom side of the enclosure. A turbine hole is arranged on the bottom side of the enclosure. A turbine is arranged in the turbine hole with a turbine seal. A crankshaft assembly has a crankshaft joined to the turbine. A piston is joined to the crankshaft assembly. A cylinder surrounds the piston and connected to the cylinder opening. A biological actuator joins the piston and a cylinder head with an artificial tendon. An electrode pad touches the biological actuator and connected to a current source with a wire and an electrode connector. Electrical current from the current sources causes the biological actuator to expand and contract, moving the piston, turning the crankshaft and transferring the mechanical energy.

In some embodiments, the biological actuator further comprises an artificial muscle. The biological feed stock further comprises a mixture of aquatic cyanobacteria in a nutrient rich water.

In some embodiments, the turbine further comprises turbine blades joined to a turbine shaft. A shaft seal connects the turbine shaft to a turbine housing. A spring is arranged within the turbine housing, connected to the turbine shaft and a spring housing. A flywheel shaft joins to the turbine shaft and a flywheel. A plurality of connecting rods joins to the crankshaft with a pin. The piston joins to the pin with a connecting rod.

### BRIEF DESCRIPTION OF THE FIGURES

The detailed description of some embodiments of the invention is made below with reference to the accompanying figures, wherein like numerals represent corresponding parts of the figures.

FIG. 1 shows a perspective view of one embodiment of the present invention;

FIG. 2 shows a bottom perspective view of one embodiment of the present invention;

FIG. 3 shows a front view of one embodiment of the present invention;

FIG. 4 shows a detail view of the cylinder of one embodiment of the present invention;

FIG. 5 shows a perspective view of the synthetic tendon and electrodes of one embodiment of the present invention;

FIG. 5A shows a perspective view of the synthetic tendon and electrodes of one embodiment of the present invention;

FIG. 6 shows a front view of one embodiment of the turbine of the present invention;

FIG. 7 shows an exploded view of one embodiment of the turbine of the present invention; and

FIG. 8 shows a perspective view of one embodiment of the turbine of the present invention.

### DETAILED DESCRIPTION OF CERTAIN EMBODIMENTS

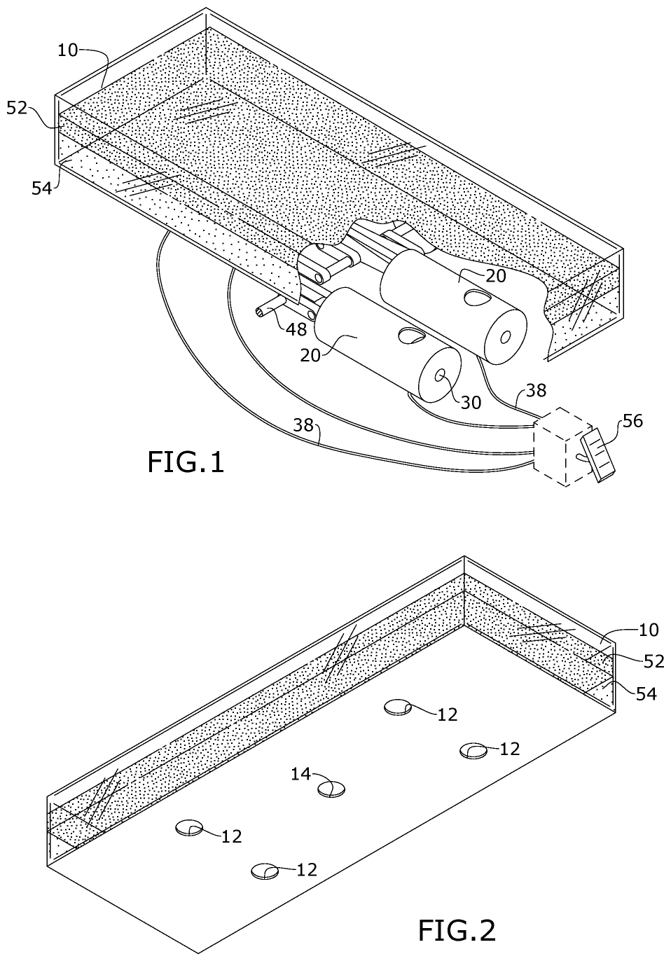

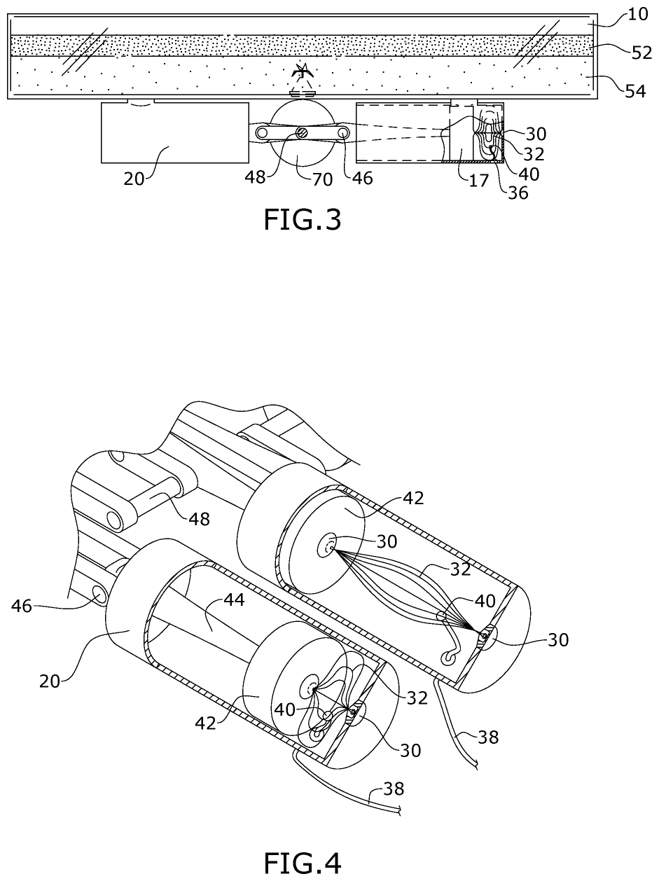

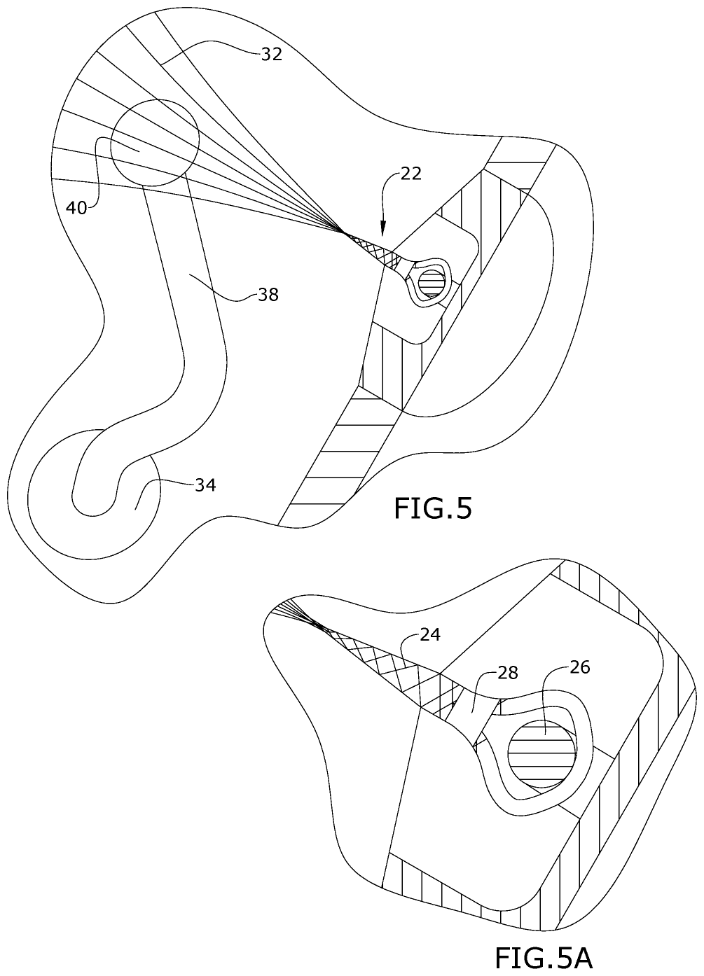

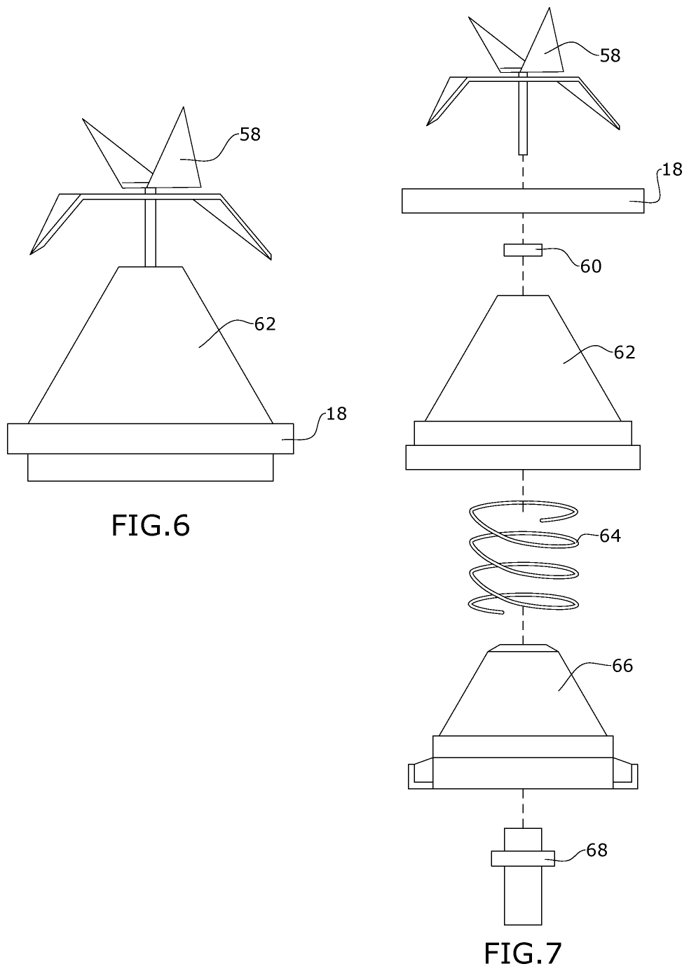

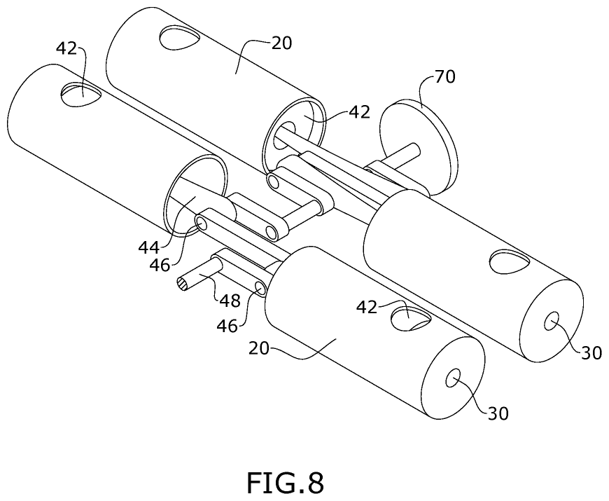

By way of example, and referring to FIGS. 1-8, one embodiment of a biological engine is configured to transfer mechanical energy from a biological actuator. The biological engine has an enclosure 10 further comprising a biological feedstock. At least one cylinder opening 12 is arranged on a bottom side of the enclosure 10. A turbine hole 14 is also arranged on the bottom side of the enclosure 10.

A turbine 16 is arranged in the turbine hole 14 with a turbine seal 18. A crankshaft assembly has a crankshaft 48 joined to the turbine. A piston 42 is joined to the crankshaft assembly. A cylinder 20 surrounds the piston 42 and is connected to the at least one cylinder opening 12. The cylinder is filled with the biological feedstock which can be drained by removing a plug 30.

A biological actuator joins the piston 42 and a cylinder head with an artificial tendon 32. An electrode pad 40 touches the biological actuator and is connected to a current source with a wire 38 and an electrode connector 34. The electrode connector 34 further comprises an electrode seal 36 which prevents the biological feedstock from leaking from the cylinder 20. Electrical current from the current sources causes the biological actuator to expand and contract, moving the piston 42, turning the crankshaft 48 and transferring the mechanical energy. A user can adjust the speed of the turbine 16 by manipulating the electrical current with an accelerator 56.

In some embodiments, the biological actuator further comprises an artificial muscle 32 joined to a synthetic tendon 22. The synthetic tendon 22 further comprises individual fibers 24 joined to a tendon anchor 26 and covered in a tendon sheath 28. In some embodiments, the tendon sheath 28 can be a removable silicone sheath.

The biological feedstock further comprises a mixture of aquatic cyanobacteria 52 in a nutrient rich water 54.

In some embodiments, the turbine 16 further comprises turbine blades 58 joined to a turbine shaft. A shaft seal 60 connects the turbine shaft to a turbine housing 62. A spring 64 is arranged within the turbine housing 62, connected to the turbine shaft and a spring housing 66. A flywheel shaft 68 joins to the turbine shaft and a flywheel 70. A plurality of connecting rods 44 join to the crankshaft 48 with a pin 46. The piston 42 joins to the pin 46 with a connecting rod 44.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. §112, ¶ 6. In particular, any use of “step of” in the claims is not intended to invoke the provision of 35 U.S.C. §112, ¶ 6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A biological engine, configured to transfer mechanical energy from a biological actuator; the biological engine comprising:
an enclosure containing a biological feedstock;
a cylinder opening, arranged on a bottom side of the enclosure;
a turbine hole, arranged on the bottom side of the enclosure;
a turbine, arranged in the turbine hole with a turbine seal;
a crankshaft assembly, further comprising, a crankshaft, joined to the turbine, a piston, joined to the crankshaft assembly;
a cylinder, surrounding the piston and connected to the cylinder opening;
a biological actuator, joining the piston and a cylinder head with an artificial tendon; an
an electrode pad, touching the biological actuator and connected to a current source with a wire and an electrode connector;
wherein electrical current from the current sources causes the biological actuator to expand and contract, moving the piston, turning the crankshaft and transferring the mechanical energy.

2. The biological engine of claim 1, wherein the biological actuator further comprises an artificial muscle.

3. The biological engine of claim 2, wherein the biological feed stock further comprises a mixture of aquatic cyanobacteria in a nutrient rich water.

4. The biological engine of claim 3, wherein the turbine further comprises;
turbine blades, joined to a turbine shaft a shaft seal, connecting the turbine shaft to a turbine housing;
a spring arranged within the turbine housing, connected to the turbine shaft and a spring housing;
a flywheel shaft, joined to the turbine shaft and a flywheel;

5. The biological engine of claim 4, a plurality of connecting rods, joined to the crankshaft with a pin;

6. The biological engine of claim 4, wherein the piston is joined to the pin with a connecting rod.
